(19) United States
(12) Patent Application Publication
(10) Pub. No.: US 2023/0214085 A1
(43) Pub. Date: Jul. 6, 2023

(54) AUTHENTICATION ALIGNMENT SYSTEM

(71) Applicant: Gentex Corporation, Zeeland, MI (US)

(72) Inventors: Richard T. Fish, JR., Hudsonville, MI (US); Daniel P. Bayer, Allendale, MI (US)

(73) Assignee: Gentex Corporation, Zeeland, MI (US)

(21) Appl. No.: 18/084,886

(22) Filed: Dec. 20, 2022

Related U.S. Application Data
(60) Provisional application No. 63/294,957, filed on Dec. 30, 2021.

(51) Int. Cl. G06F 3/04817; G06F 21/32; G01B 11/02

(52) U.S. Cl. CPC G06F 3/04817; G06F 21/32; G01B 11/026

(57) ABSTRACT

A feedback apparatus for a user identification system of a vehicle includes an indicator device configured to selectively activate a status icon and a plurality of directional segments disposed around the status icon. A controller is in communication with a scanning device configured to authenticate an object depicted in image data representing a field of view. The controller is configured to identify an alignment direction of the object within the field of view and activate one or more of the directional segments in response to the alignment direction. Additionally, the controller is configured to activate the status icon in response to the alignment direction indicating that the object is aligned in the field of view.

### CROSS-REFERENCE TO RELATED APPLICATIONS

This application claims priority under 35 U.S.C. § 119(e) and the benefit of U.S. Provisional Application No. 63/294,957 entitled AUTHENTICATION ALIGNMENT SYSTEM, filed on Dec. 30, 2021, by Richard T. Fish, Jr., et al., the entire disclosure of which is incorporated herein by reference.

### TECHNOLOGICAL FIELD

The present invention generally relates to an identification or monitoring system and, more particularly, to an alignment feedback apparatus for an identification or monitoring system.

### SUMMARY OF THE DISCLOSURE

According to one aspect of the present disclosure, a feedback apparatus for a user identification system of a vehicle is disclosed. The apparatus may include an indicator device configured to selectively activate a status icon and a plurality of directional segments disposed around the status icon. A controller is in communication with a scanning device configured to authenticate an object depicted in image data representing a field of view. The controller is configured to identify an alignment direction of the object within the field of view and activate one or more of the directional segments in response to the alignment direction. Additionally, the controller is configured to activate the status icon in response to the alignment direction indicating that the object is aligned in the field of view.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1A is an illustrative view of an authentication system incorporated in a passenger compartment of an automotive vehicle;

FIG. 1B is an illustrative view of an authentication system incorporated on an exterior panel of an automotive vehicle;

FIG. 2 is a partially exploded view of a scanning device demonstrating a feedback apparatus;

FIG. 3 is a diagram of an alignment symbol comprising a plurality of alignment features or segments configured to visually instruct a directional alignment with a scanning device of an authentication system;

FIG. 4A is a diagram of an alignment animation displayed by a feedback apparatus demonstrating a lateral alignment instruction;

FIG. 4B is a diagram of an alignment animation displayed by a feedback apparatus demonstrating a vertical alignment instruction;

FIG. 5A is a diagram of an alignment animation displayed by a feedback apparatus demonstrating a proximity alignment instruction;

FIG. 5B is a diagram of an alignment animation displayed by a feedback apparatus demonstrating a proximity alignment instruction;

FIG. 6 is a diagram of an alignment indication displayed by a feedback apparatus demonstrating an alignment confirmation indication; and

FIG. 7 is a block diagram of an authentication system incorporating a scanning device and a feedback apparatus in accordance with the disclosure.

### DETAILED DESCRIPTION

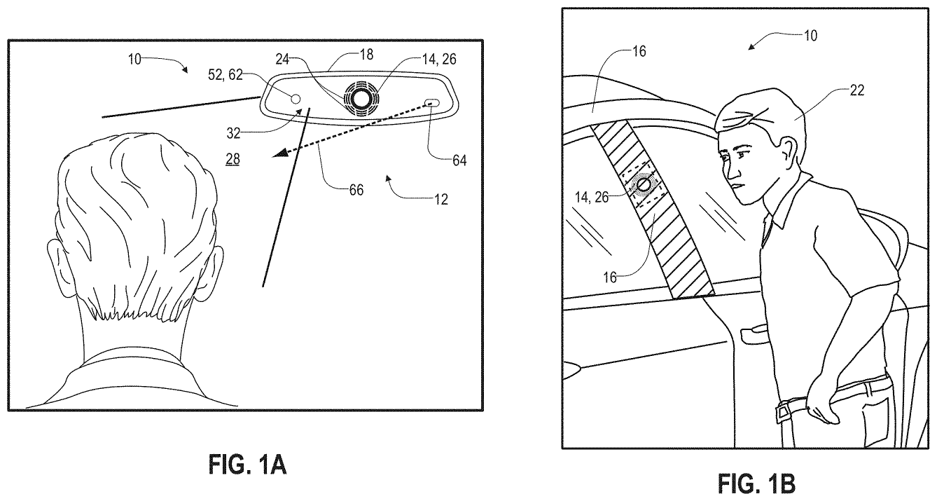

For purposes of description herein, the terms “upper,” “lower,” “right,” “left,” “rear,” “front,” “vertical,” “horizontal,” and derivatives thereof shall relate to the invention as oriented in FIG. 1A. Unless stated otherwise, the term “front” shall refer to the surface of the element closer to an intended viewer of the mirror element, and the term “rear” shall refer to the surface of the element further from the intended viewer of the mirror element. However, it is to be understood that the invention may assume various alternative orientations, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

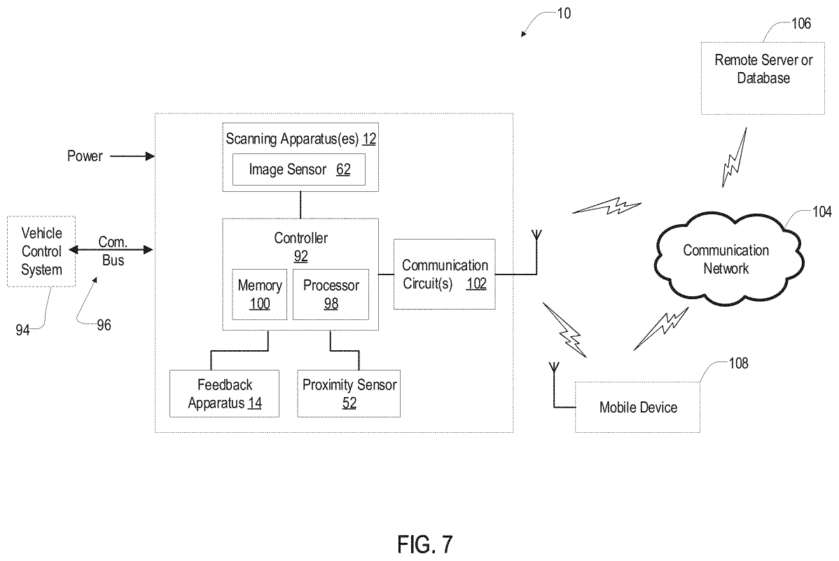

Referring to FIGS. 1A and 1B, an exemplary embodiment of an authentication system 10 is shown. In general, the system 10 may comprise a scanning device 12 configured to capture data that may be used to identify and authenticate a potential user or operator. In some embodiments, the system 10 may be configured to capture biometric data in the form of image data, which may be processed by a controller to load, authorize, unlock, and/or verify one or more privileges, actions, and/or transactions associated with the system 10. In general, the disclosure provides an alignment feedback apparatus 14 used to communicate alignment instructions. In operation, the feedback apparatus 14 may be configured to visually present an indication of an extent of a feature or content of the scanning data of the scanning device 12. In this way, a position or orientation of the operator or user may be adjusted for alignment with the scanning device 12. Accordingly, the system 10 may provide feedback information, alignment information, and/or instructions to ensure effective and intuitive operation without undue hardship for users. Further details of a controller are discussed in reference to the block diagram of the system 10 demonstrated in FIG. 7.

As shown in FIGS. 1A and 1B, the system 10 may be incorporated in various portions of a vehicle 16. As shown in FIG. 1A, the scanning device 12 is incorporated in a mirror or rearview assembly 18 of the vehicle 16. FIG. 1B demonstrates another configuration of the system 10 with the scanning device 12 incorporated in an exterior panel 20 (e.g., a B-pillar trim panel). Though demonstrated in reference to the vehicle 16, the system 10 may be implemented in a variety of settings to provide authentication for access to barriers or entry doors, authorization of transactions (e.g. banking transactions, purchases, etc.), and various additional applications that may benefit from secure authorization of a user 22. In some embodiments, the feedback apparatus 14 may be concealed behind a mirror element 18a of the rearview assembly 18 or the exterior panel 20. Once activated, one or more segments 24 of the feedback apparatus 14 may illuminate through the mirror element 18a or the exterior panel 20 to provide alignment guidance to the user 22 in the form of visual cues. Accordingly, the disclosure may provide for a flexible solution that may be implemented in a variety of ways to suit a desired operation or application.

In some embodiments, the scanning device 12 may be disposed or incorporated in various portions of the vehicle 16 to provide for access to various compartments or portions of the vehicle 16. For example, the user 22 may be authorized to access a trunk of the vehicle to receive a delivery or collect an item. In this way, the system 10 may provide for selective access through one or more gates, doors, and access panels and may be additionally operable to provide an authorization for the user 22 to complete various operations or transactions. Accordingly, the scanning device 12 may be incorporated in various portions of the vehicle 16 (e.g., a pillar, trunk, spoiler, hood, roof, etc.) or various other structures for convenient incorporation in a variety of environments. The various beneficial aspects of the system 10 are further discussed in the following detailed description.

In general, the feedback apparatus 14 may comprise a plurality of emitters configured to selectively or independently illuminate each of the segments 24 of the alignment symbol 26. For example, in some implementations, the feedback apparatus may correspond to a display screen (e.g., a liquid crystal display [LCD], light emitting diode [LED] display, organic LED [OLED] display, etc.) comprising emitters that illuminate pixels that combine to form the segments 24. In such cases, the display screen may additionally be configured to display image data from cameras (e.g., a rearview camera) of the vehicle 16. In some implementations, feedback apparatus may be implemented by a dedicated array or patter of emitters (e.g., LEDs, red-green-blue LEDs, etc.) aligned to form the segments 24. Additionally, light guides or diffusers may be positioned between the emitters and the user 22 to illuminate the segments 24 uniformly. In each case, the controller of the system 10 may be configured to selectively or independently illuminate each of the segments 24 to communicate alignment instructions from the feedback apparatus 14.

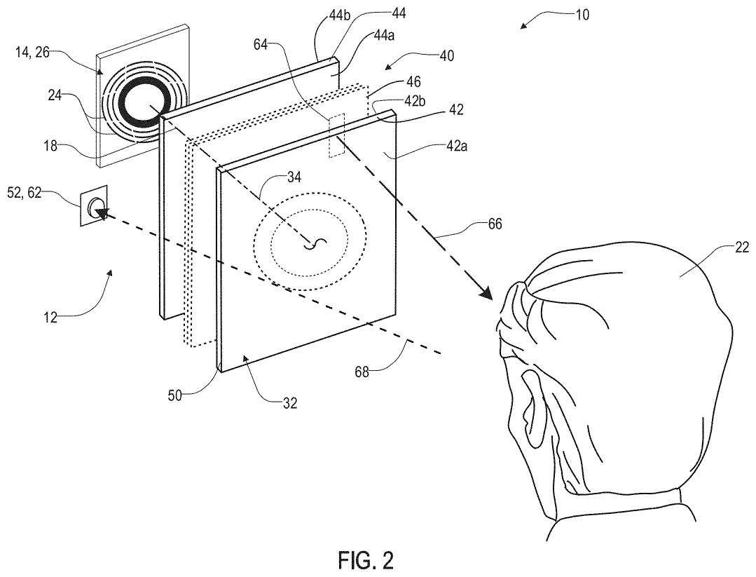

An example of the scanning device 12 and the feedback apparatus 14 of the system is shown in a partially exploded assembly view in FIG. 2. Referring now to FIGS. 1A, 1B, and 2, the scanning device 12 may be operable to perform an identification function, which may be activated upon detection of the user 22 interacting or being detected proximate to the scanning device 12 via a scanning device 12 and/or a proximity sensor 52. Once the scanning device is activated, a controller of the system 10 may activate an alignment symbol 26 by illuminating one or more of the segments 24. Once activated, the light projected from the segment(s) of the feedback apparatus 14 may illuminate a surface (e.g., the mirror element 18a, exterior panel 20, etc.) proximate to or aligned with a field of view 28 of the scanning device 12. Each of the illuminated segments 24 or portions of the feedback apparatus 14 activated by the controller of the system 10 may communicate a visual instruction. The visual instructions may provide various visual directional cues that direct the user 22 to align one or more scanning features (e.g., an eye, face, etc.) within the field of view 28. Once the user 22 is aligned within the field of view 28, the controller of the system 10 may capture scanning or image data necessary to identify the user via an authentication routine.

As shown in FIG. 2, the scanning device 12 and the feedback apparatus 14 may both be concealed behind a display surface 32 that transmits light depicting the alignment symbol 26 as an alignment emission 34. The alignment emission 34 may be output from the feedback apparatus 14, thereby illuminating and revealing one or more of the segments 24 on the display surface 32 to provide an alignment instruction. In the case of the feedback apparatus 14 implemented in the rearview assembly 18, the mirror element 18a may provide for the display surface 32. Alternatively, the exterior panel 20 may similarly provide for the display surface 32 where the feedback apparatus 14 on an exterior portion or panel of the vehicle 16. As shown, FIG. 2 represents embodiments of the feedback apparatus 14 implemented in the rearview assembly 18 as well as the exterior panel 20. While the corresponding features of each of these examples are discussed separately, it shall be understood that features of these examples may be applied to utilize the system 10 in various mirrored devices or behind various panels of the vehicle 16.

As discussed in reference to FIG. 1A, the feedback apparatus 14 may be implemented in a rearview assembly 18. In various examples, the rearview assembly 18 may correspond to a conventional reflective mirror assembly, an auto-dimming mirror (e.g., electrochromic), a video display mirror, or other similar devices. As shown in FIG. 2, the rearview assembly 18 may correspond to an auto-dimming or transflective mirror assembly that may vary in reflectance-based signals (e.g., a voltage potential) output adjusted by a controller. In such implementations, the rearview assembly 18 may include an electro-optic mirror device 40. The mirror device 40 may include a first substrate 42 having a first surface 42a and a second surface 42b. The mirror device 40 may further comprise a second substrate 44 having a third surface 44a and a fourth surface 44b. The first substrate 42 and the second substrate 44 may define a cavity 46 and may be substantially parallel. The first surface 42a and the third surface 44a may be oriented toward the display surface 32 of the mirror device 40. The second surface 42b and the fourth surface 44b may be oriented away from the display surface 32 toward the feedback apparatus 14. In operation, the alignment emission 34 may pass through one or more directionally reflective portions of the mirror device 40 allowing the activated segments 24 of the alignment symbol 26 to be illuminated on the display surface 32. In this configuration, the feedback apparatus 14 may be concealed behind the mirror device 40 within the rearview assembly 18.

As discussed in reference to FIG. 1B, the feedback apparatus 14 may be disposed behind a panel (e.g., the exterior panel 20) of the vehicle 16. In some cases, the mirror device 40 may be implemented in a portion of the exterior panel 20 to provide the display surface 32 similar to the rearview assembly 18. Alternatively, the feedback apparatus 14 may simply be masked behind a concealment pane 50 or panel formed within the exterior panel 20. For example, the concealment pane 50 may correspond to a tinted substrate that blends with the exterior panel 20 when exposed to natural or ambient light. As shown in FIG. 2, in response to the activation of the alignment emission 34, the portions of the concealment pane 50 may be illuminated revealing the active segment(s) 24 of the alignment symbol 26. In this configuration, the selective activation of the alignment emission 34 from the feedback apparatus 14 may provide for visual instructions to be provided to the user 22 to align within the field of view 28. Additionally, when the feedback apparatus 14 is not in use, scanning device 12 and the feedback apparatus 14 may be concealed behind the concealment pane 50.

Still referring to FIG. 2, in some embodiments, the scanning device 12 may provide for the system 10 to identify or authenticate the user 22 of a vehicle 16 based on an eye-scan identification function. The eye-scan-identification function may utilize an infrared illumination to illuminate an eye of the user 22 for the identification. Such illumination may be optimized in conditions allowing for a high optical transmittance in the near-infrared (NIR) range. In some embodiments, the disclosure may provide for the electro-optic mirror device 40 to have an electrochromic (EC) stack having a light transmittance in the NIR range greater than 20% or more for wavelengths of light from 800 nm to 940 nm. In some embodiments, the range of wavelengths may comprise a range from approximately 700 nm to 940 nm. Additionally, in some implementations, the electro-optic device 20 may comprise a plurality of light sources or infrared emitters 64 configured to illuminate at least one iris of the user 22 of the vehicle 16.

In order to detect the user 22, the system 10 may implement the scanning device and/or a proximity sensor 52. The proximity sensor 52 may correspond to a capacitive sensor, radar sensor, Doppler sensor, ultrasonic sensor, image or light sensor, or various other sensors that may be configured to identify the presence of the user 22 or similar object proximate to the scanning device 12. In various embodiments, the controller of the system 10 may monitor signals from the proximity sensor 52 and selectively activate the feedback apparatus 14 in response to the presence of the user 22. Additionally or alternatively, the system 10 may detect the presence of the user 22 based on one or more inputs from a user interface, which may operate in response additional sensors that may be incorporated in the vehicle 16.

To provide for the eye-scan-identification function, for example, an iris scan, an image sensor 62 of the scanning device 12 may be disposed proximate to a rear surface (e.g., the fourth surface 44b) of the electro-optic mirror device 40. The image sensor 62 may correspond to, for example, a digital charge-coupled device (CCD) or complementary metal-oxide-semiconductor (CMOS) active pixel sensor, although may not be limited to these exemplary devices. The image sensor 62 may be in communication with at least one light source, which may be in the form of one or more infrared emitters 64. In operation, the infrared emitters may be configured to output an identification emission 66 of light in the NIR range (e.g., 700 nm to 940 nm, 750 nm to 800 nm, etc.). In some embodiments, wavelengths ranging from 750 nm to 800 nm may be utilized for the emission or 750 nm to 800 nm to suit one or more iris recognition functions. The identification emission 66 may be reflected from the user 22 as reflected light 68 that may be received by the image sensor 62 to process the identification of the user 22. In this configuration, the image sensor 62 may be configured to selectively activate the one or more infrared emitters 64 corresponding to the at least one light source 64 to illuminate the iris such that an identity of a user 22 of the vehicle 16 may be determined.

As later discussed in reference to FIG. 7, the image sensor 62 may be disposed on, for example, a printed circuit board in communication with the controller of the system 10. The controller may further be in communication with various devices that may be incorporated in the vehicle 16 via the communication bus or any other suitable communication interface. The controller may correspond to one or more processors or circuits, which may be configured to process image data received from the image sensor 62. In this configuration, the image data may be communicated from the image sensor 62 to the controller. The controller may process the image data with one or more algorithms configured to determine an identity of the user 22 of the vehicle 16.

Though demonstrated in FIG. 2 as being disposed behind the display surface 32, the image sensor 62 and the infrared emitters 64 may be alternatively positioned in various embodiments. For example, though discussed as being positioned with the feedback apparatus 14 (e.g., in the rearview assembly 18), the image sensor 62 and/or infrared emitter(s) 64 may be hidden or mounted elsewhere on the vehicle 16. In some implementations, the image sensor 62 and/or infrared emitter(s) 64 may be concealed by one of more materials, panels, and/or coatings that are transmissive in the NIR range of light. Such materials may disguise the image sensor 62 and/or the infrared emitters 64 from view without limiting their operation. In this way, the image sensor 62 and the infrared emitters 64 may be positioned to orient the field of view 28 of the image sensor 62, such that the user 22 may align with the identifying feature (e.g., a facial feature, eyes, etc.) even though the image sensor 62 and the infrared emitters 64 may not necessarily be aligned with the feedback apparatus 14.

Referring again to the electro-optic mirror device 40 demonstrated in FIG. 2, a transflective coating may be disposed on the third surface 44a or the fourth surface 44b. The transflective coating may typically comprise a layer containing silver along with additional layers, such as metal, dielectric and/or transparent conducting oxides located above or below the silver comprising layer or both. The transflective coating may be implemented as a dielectric coating designed to resolve the issues related to the limited transmission in the NIR range through the mirror device to provide NIR transmittance greater than about 20%. The dielectric coating is designed to attain a reflectance level comparable to industry standard, i.e., about 40% to 85%, or about 50% to 75%, or about 55% to 70%. Additionally, the dielectric coating can be designed to attain a neutral color appearance in the visible color range for normal incidence viewing angle up to broad viewing angles. In this way, the disclosure provides for improved transmittance in the NIR range while maintaining visible color performance and mirror functionality.

The electro-optic mirror device 40 may incorporate an electrochromic element. The electrochromic element may comprise an electrochromic medium, which includes at least one solvent, at least one anodic material, and at least one cathodic material. Typically, both of the anodic and cathodic materials are electroactive and at least one of them is electrochromic. It will be understood that regardless of its ordinary meaning, the term “electroactive” will be defined herein as a material that undergoes a modification in its oxidation state upon exposure to a particular electrical potential difference. Additionally, it will be understood that the term “electrochromic” will be defined herein, regardless of its ordinary meaning, as a material that exhibits a change in its extinction coefficient at one or more wavelengths upon exposure to a particular electrical potential difference.

Electrochromic components, as described herein, include materials whose color or opacity are affected by electric current, such that when an electrical current is applied to the material, the color or opacity changes from a first phase to a second phase. The electrochromic component may be a single-layer, single-phase component, multi-layer component, or multi-phase component, as described in U.S. Pat. No. 5,928,572 entitled “Electrochromic Layer and Devices Comprising Same;” U.S. Pat. No. 5,998,617 entitled “Electrochromic Compounds;” U.S. Pat. No. 6,020,987 entitled “Electrochromic Medium Capable of Producing a Pre-selected Color;” U.S. Pat. No. 6,037,471 entitled “Electrochromic Compounds;” U.S. Pat. No. 6,141,137 entitled “Electrochromic Media for Producing a Preselected Color;” U.S. Pat. No. 6,241,916 entitled “Electrochromic System;” U.S. Pat. No. 6,193,912 entitled “Near Infrared-Absorbing Electrochromic Compounds and Devices Comprising Same;” U.S. Pat. No. 6,249,369 entitled “Coupled Electrochromic Compounds With Photostable Dication Oxidation States;” U.S. Pat. No. 6,137,620 entitled “Electrochromic Media With Concentration-Enhanced Stability, Process for the Preparation Thereof and Use in Electrochromic Devices;” U.S. Pat. No. 6,519,072, entitled “Electrochromic Device;” and International Patent Application Serial Nos. PCT/US98/05570 entitled “Electrochromic Polymeric Solid Films, Manufacturing Electrochromic Devices Using Such Solid Films, and Processes For Making Such Solid Films And Devices;” and PCT/EP98/03862 entitled “Electrochromic Polymer System,” which are herein incorporated by reference in their entirety.

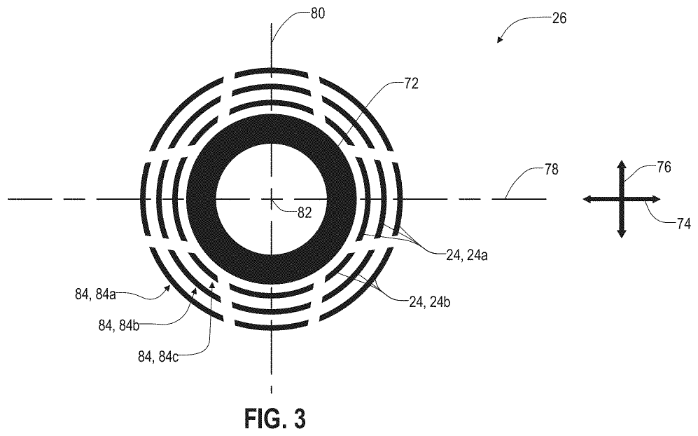

Referring now to FIGS. 3-5B, the exemplary operation of the alignment symbol 26 is shown demonstrating a plurality of visual cues that provide alignment instructions to the user 22. Based on the selective activation of the segments 24 or portions of the alignment symbol 26, the controller of the system 10 may additionally identify an operating state of the scanning device 12. As discussed previously, the segments 24 or portions forming the alignment symbol 26 may correspond to or be aligned with pixels or light sources that may be controlled to independently illuminate each of the depicted segments 24. In this way, the controller of the system 10 may control the sequential activation of each of the segments 24 to provide animated or sequential visual cues to instruct the user 22 to align within the field of view 28. Various examples of animated or sequential visual cues are discussed in the following examples shown in FIGS. 3-6.

Referring now to FIG. 3, an example of the alignment symbol 26 comprising a plurality of alignment features or segments 24 is shown. In various examples, the feedback apparatus 14 may include an indicator device (e.g., light segments, display screen, etc.) configured to communicate visual instructions for alignment with the scanning device 12 of the system 10. As shown in FIG. 3, the alignment symbol 26 is demonstrated with each of the segments 24, as well as a central status icon 72, illuminated. Though the status icon 72 and the surrounding segments 24 are demonstrated in the color black, it shall be understood that each of the features or portions of the alignment symbol 26 may be illuminated in a wide variety of colors as provided by one or more emitters (e.g., RGB emitters) forming the feedback apparatus 14. Accordingly, the alignment symbol 26, as shown in FIG. 3, demonstrates a representation of the light output via the display surface 32 by the alignment emission 34 for all of the segments 24 and the status icon 72 as previously discussed.

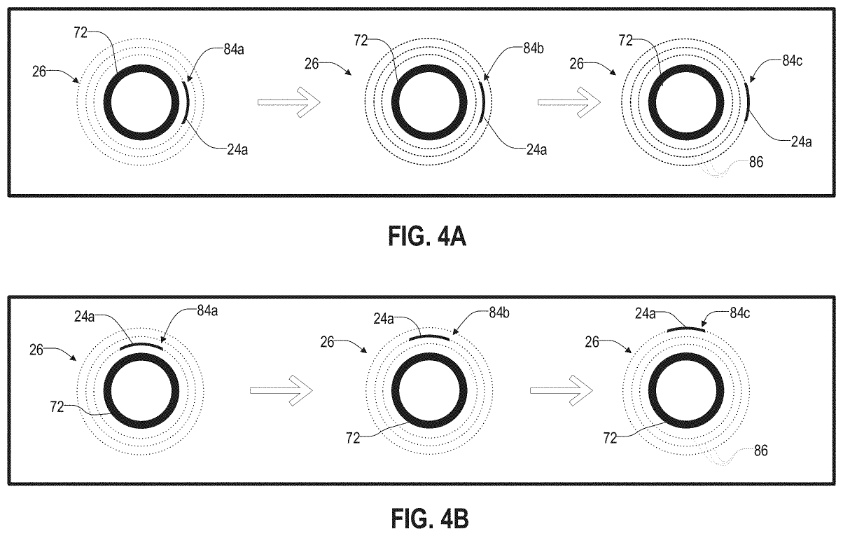

The general operation of the feedback apparatus 14 may provide for two primary instructions to be communicated to the user 22. The first visual instruction may correspond to a directional instruction that communicates a lateral 74 or vertical 76 adjustment of the user 22 within the field of view 28. The lateral direction 74 is aligned with a corresponding lateral axis 78 and the vertical direction 76 is aligned with a vertical axis 80. Extending along each of the lateral axis 78 and the vertical axis 80, the segments 24 and the directional segments 24a may be formed as spark-shaped segments spaced apart about a perimeter of the status icon 72. Each of the directional segments 24a may be positioned concentrically outward from a center 82 of the alignment symbol 26 positioned centrally along the lateral axis 78 and the vertical axis 80. In this configuration, the controller of the system 10 may communicate a directional alignment instruction by sequentially activating each of the directional segments 24a in the lateral direction 74 and/or the vertical direction 76 to instruct the user 22 for alignment within the field of view 28. A further detailed example of the sequential activation of the directional segments 24a is further discussed in reference to FIGS. 4A and 4B.

Between each of the directional segments 24a, intermediate segments 24b may extend along a similar or the same arcuate path of the directional segments 24a. Accordingly, the combination of the direction segments 24a and the intermediate segments 24b may form a plurality of concentric rings 84 extending about the status icon 72. Each of the concentric rings 84 may include a different diameter, such that the concentric rings 84 are evenly spaced about the perimeter. More specifically, a first concentric ring 84a may include a first diameter, a second concentric ring 84b may include a second diameter, and a third concentric ring 84c may include a third diameter. The first diameter may be less that the second diameter, and the second diameter may be less than the third diameter. In this configuration, each of the concentric rings 84 may extend outward from the center 82 of the symbol 26. In this configuration, the controller of the system 10 may selectively activate each of the segments to provide both directional instructions and proximity instructions to assist the user 22 with an alignment in the field of view 28.

As previously discussed, the status icon 72 may be disposed centrally within the segments 24. As demonstrated in FIG. 3, the status icon 72 may form a round or annular shape equally shaped at its perimeter from the center 82 and centered within the concentric rings 84. The controller of the system 10 may selectively activate the status icon 72 to provide an indication of an alignment or operating status of the scanning device 12. Further examples of the operation of the feedback apparatus 14 are provided in reference to FIGS. 4A, 4B, 5A, 5B, and 6.

Referring to FIG. 4A, an exemplary alignment animation is shown demonstrating a lateral alignment instruction from the feedback apparatus 14. In operation, the controller may selectively activate each of the directional segments 24a along the lateral axis 78 to communicate an adjustment is necessary in the lateral direction 74 (e.g., a right direction as shown). The sequential activation for the directional segments 24a may emphasis the instruction to adjust in the lateral direction 74 by successively illuminating each of the directional segments 24a in the first concentric ring 84a, the second concentric ring 84b, and the third concentric ring 84c. Accordingly, the feedback apparatus 14 may provide for the dynamic, sequential illumination of each of the directional segments 24a to instruct the user 22 to adjust in the direction necessary for alignment within the field of view 28. Note that each of the exemplary depictions of the alignment symbol 26 represented in FIGS. 4A, 4B, 5A, 5B, and 6 includes concentric reference lines 86 demonstrated in phantom for perspective in relation to the activation of each of the concentric rings 84.

Referring now to FIG. 4B, an alignment animation of the feedback apparatus 14 is shown demonstrating a vertical alignment instruction in the vertical direction 76. Similar to the lateral alignment instruction, the controller may sequentially activate each of the directional segments 24a extending in the vertical direction 76 in a sequence beginning with the first concentric ring 84a, followed by the second concentric ring 84b, and then the third concentric ring 84c. In this way, the controller of the system 10 may provide for the dynamic activation of each of the directional segments 24a in the lateral direction 74 to instruct the user 22 to adjust an alignment within the field of view 28. Though discussed specifically in relation to the sequential activation of each of the segments 24, it shall be understood that each of the segments 24 and the status icon 72 may be sequentially or successively illuminated in various patterns to provide visual instructions to the user 22 in accordance with the disclosure.

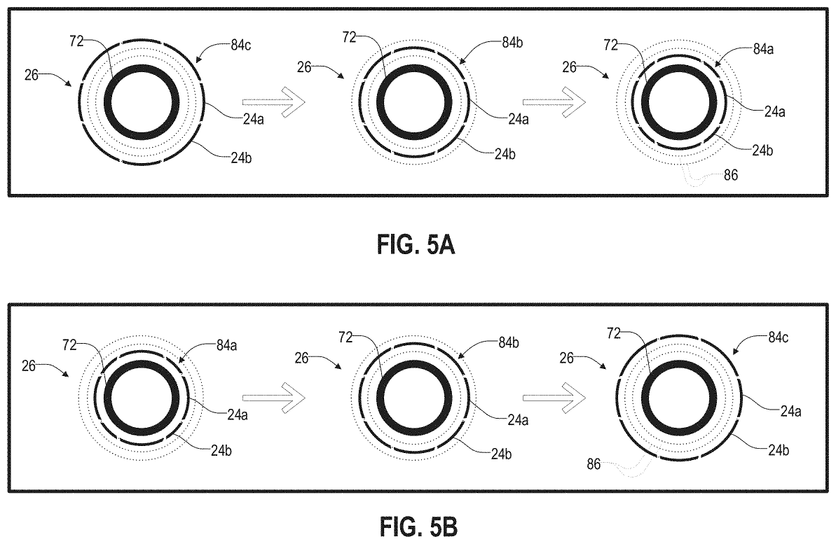

Referring now to FIGS. 5A and 5B, the exemplary operation of the feedback apparatus 14 communicating a proximity alignment instruction is shown. As demonstrated in FIG. 5A, the controller of the system 10 may communicate the proximity instruction to the user 22 by activating the third concentric ring 84c followed by the second concentric ring 84b and then the first concentric ring 84a. The successive activation of each of the concentric rings 84 may provide suggested illumination of the alignment symbol 26 that may urge or draw the user 22 to move toward the feedback apparatus 14. Additionally, as depicted in FIG. 5B, an opposite proximity instruction may be communicated by the feedback apparatus 14. More specifically, the controller of the system 10 may selectively or sequentially activate the first concentric ring 84a, followed by the second concentric ring 84b, and then activate the third concentric ring 84c. The successive activation of the concentric rings 84 as depicted in FIG. 5B may provide for suggestive illumination of the alignment symbol 26 that urges the user 22 to move away from the feedback apparatus 14. Accordingly, the sequential illumination of the concentric rings 84 may provide for simple yet meaningful communication of a proximity instruction that may instruct the user 22 to move closer or further away from the feedback apparatus 14.

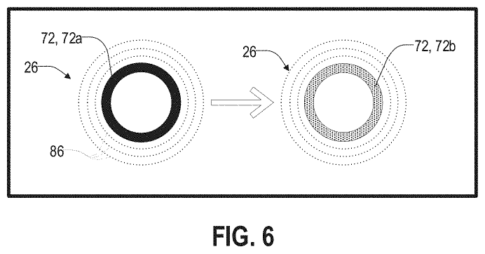

Referring now to FIG. 6, an alignment or status indication of the scanning device 12 is shown in relation to the status icon 72 of the feedback apparatus 14. As previously discussed, the status icon 72 may be illuminated in a variety of colors or patterns of colors which may be controlled via the light sources implemented to illuminate one or more light guides associated with the status icon 72. As demonstrated in FIG. 6, the status icon 72 may be changed from a first status 72a to a second status 72b by the controller of the system 10. The first status 72a may illuminate the status icon 72 in a first color (e.g., blue), and the second status 72b may illuminate the status icon 72 in a second color (e.g., green). Accordingly, the controller of the system 10 may selectively activate the illumination color of the status icon 72 to communicate visual feedback to the user 22. The visual feedback may correspond to an adjustment of the status of the scanning device 12, the feedback apparatus 14 and/or various components of the system 10, which may further be in communication with the vehicle 16.

Referring to FIG. 7, a block diagram of the system 10 incorporating the scanning device 12 and the feedback apparatus 14 is shown. In FIG. 7, the controller 92 of the system 10 is shown in communication with the scanning device 12 and the feedback apparatus 14. The controller 92 may further be in communication with a control module 94 via a communication bus 96 of the vehicle 16. The communication bus 96 may be configured to deliver signals to the controller 92 identifying various states of the vehicle 16. For example, the communication bus 96 may be configured to communicate to the controller 92 a drive selection of the vehicle 16, an ignition state, a door open or ajar status, a remote activation of the scanning device 12, etc. Such information and control signals may be utilized by the controller 92 to activate or adjust various states and/or control schemes of the scanning device 12 and the feedback apparatus 14.

The controller 92 may comprise a processor 98 having one or more circuits configured to control various operations of the system 10. The processor 98 may be in communication with a memory 100 configured to store instructions to control operations of the scanning device 12. For example, the controller 92 may be configured to store one or more characteristics or profiles utilized by the controller 92 to identify the user 22 of the vehicle 16. In this configuration, the controller 92 may communicate operating and identification information with the scanning device 12 to identify the user 22 of the vehicle 16. Additionally, based on the identification of the user 22, the controller 92 may be configured to control and/or communicate with additional systems of the vehicle 16. Such systems may include a security system, speed governor, radio/infotainment system, etc. In this way, one or more systems of the vehicle 16 may be controlled or restricted based on the identity of the user 22.

In some embodiments in response to an identification of a passenger or user 22 of the vehicle 16, the controller 92 may access a database of stored driver preferences to customize aspects of the vehicle 16. For example, the controller 92 may access and enable radio station presets according to a driver's pre-established preferences. Navigation and/or map display settings may be changed or set according to a driver's pre-established preferences. Additionally, the system 10 may be utilized to customize a seat position or height and adjust various operating parameters before the user 22 even enters vehicle. For example, the system may be operable to start the vehicle 16, activate a radio to a preconfigured station or playlist, and activate a climate control to a user setting. Additionally, the database may comprise navigation information comprising known or previously visited locations. In particular, a route to home, work, or other frequently visited locations may be preset upon identification of a driver based on previous use or programming stored in the database.

In an exemplary embodiment, the controller 92 may be configured to process image data received from the image sensor 62. In this configuration, the controller 92 may process the image data with one or more algorithms configured to determine an identity of the user 22 of the vehicle 16. With the identity of the user 22 or one or more passengers of the vehicle 16 identified, the controller 92 may further be operable to control various systems or functions of the vehicle 16.

Though discussed in exemplary reference to the vehicle 16, the system 10 may similarly be implemented to authenticate users to control access or entry through doors or access gates into various buildings, office structures, residences, etc. Similarly, the system 10 may be utilized to authorize various transactions (e.g. access points, purchases, bank transactions, etc.) For example, in a residential setting, the system 10 may be in communication with a smart home system. In such embodiments, based on an authentication of the user 22, the system 10 may grant access to a door or gate of a home and control one or more devices in communication with the smart-home system to load specific settings or preferences of the user 22. In another example, the system 10 may be in communication with a secure authentication system. In such embodiments, based on authentication of the user 22, the system 10 may authorize purchases for the user 22 at secure authentication terminals or grant access to automated teller machines (ATMs) and other banking facilities if the system 10 is in communication with the secure authentication system. Accordingly, the system 10 may be configured to suit a variety of applications without departing from the spirit of the disclosure.

In some embodiments, the controller 92 may utilize the identification of the user 22 of the vehicle 16 to report updates to an administrator of the system 10. For example, in some embodiments, the controller 92 may further comprise one or more communication circuits 102 configured to communicate via a communication network 104. Accordingly, the system 10 may be in communication with a remote server 106 and/or a mobile device 108 via the communication network 104. The communication network 104 may comprise one or more wireless or wired network interfaces or communication protocols. As discussed herein, wireless communication protocols may operate in accordance with communication standards including, but not limited to Institute of Electrical and Electronic Engineering (IEEE) 802.11 (e.g., WiFi™); Bluetooth®; advanced mobile phone services (AMPS); digital AMPS; global system for mobile communications (GSM); code division multiple access (CDMA); Long Term Evolution (LTE or 4G LTE); local multipoint distribution systems (LMDS); multi-channel-multi-point distribution systems (MMDS); RFID; and/or variations thereof. In this configuration, the controller 92 may be configured to send an alert or message to the administrator of the system 10 in response to one or more predetermined events. The alert or message may correspond to a text message, data message, email, alert via an application operating on a smart device, etc.

It will be appreciated that embodiments of the invention described herein may be comprised of one or more conventional processors and unique stored program instructions that control one or more processors to implement, in conjunction with certain non-processor circuits, some, most, or all of the functions of the feedback apparatus 14, as described herein. The non-processor circuits may include, but are not limited to, signal drivers, clock circuits, power source circuits, and/or user input devices. As such, these functions may be interpreted as steps of a method used in using or constructing a classification system. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, the methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

It will be understood by one having ordinary skill in the art that construction of the described invention and other components is not limited to any specific material. Other exemplary embodiments of the invention disclosed herein may be formed from a wide variety of materials unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the invention as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

What is claimed is:

1. A feedback apparatus for a user identification system of a vehicle, the apparatus comprising:
an indicator device configured to selectively illuminate a status icon and a plurality of directional segments disposed around the status icon; and
a controller in communication with a scanning device configured to authenticate an object depicted in image data representing a field of view, wherein the controller is configured to:
identify an alignment direction of the object within the field of view;
activate one or more of the directional segments in response to the alignment direction; and
activate the status icon in response to the alignment direction indicating that the object is aligned in the field of view.

2. The feedback apparatus according to claim 1, wherein the directional segments each form arc-shaped segments spaced about a perimeter of the status icon.

3. The feedback apparatus according to claim 2, wherein the arc-shaped segments form a plurality of directional segments in each of four directions positioned centrally along a vertical axis and a horizontal axis that bisect the status icon.

4. The feedback apparatus according to claim 3, wherein the controller communicates the alignment direction by activating a selection of the directional segments sequentially outward from the status icon.

5. The feedback apparatus according to claim 2, further comprising:
intermediate segments disposed between each of the directional segments.

6. The feedback apparatus according to claim 5, wherein the directional segments and the intermediate segments together form at least one concentric ring extending about the perimeter of the status icon.

7. The feedback apparatus according to claim 6, wherein the at least one concentric ring comprises a plurality of concentric rings, wherein each of the concentric rings comprises the arc-shaped segments positioned centrally along a vertical axis and a horizontal axis that bisect the status icon.

8. The feedback apparatus according to claim 7, wherein the controller is configured to communicate a proximity adjustment of the object relative to the scanning device by sequentially activating one or more of the concentric rings.

9. The feedback apparatus according to claim 8, wherein the sequential activation comprises:
activating the concentric rings sequentially outward away from the status icon in response to the proximity adjustment indicating the object is too close to the scanning device.

10. The feedback apparatus according to claim 9, wherein the sequential activation comprises:
activating the concentric rings sequentially inward toward the status icon in response to the proximity adjustment indicating the object is too far from the scanning device.

11. The feedback apparatus according to claim 1, wherein the status identifier portion forms to an annular shape.

12. The feedback apparatus according to claim 1, wherein the controller is configured to change an illumination color of the status identifier portion in response to the status of a scanning routine processed by the scanning device.

13. The feedback apparatus according to claim 1, wherein the object is a human user, and the image data depicts a biometric feature of the user.

14. A method for providing visual feedback for a user identification system of a vehicle, the method comprising:
monitoring image data captured in a field of view;
identifying a position of an object in the field of view based on the image data;
generating a positioning instruction in response to the position of the object;
activating one or more of the directional segments of an indicator device in response to the positioning instruction; and
activating a status icon of the indicator device in response to the alignment direction indicating that the object is aligned in the field of view.

15. The method according to claim 14, wherein the directional segments are circumferentially spaced about a perimeter of the status icon, and the method further comprising:
communicating the alignment instruction as a directional instruction by activating a selection of the directional segments sequentially outward from the status icon.

16. The method according to claim 14, further comprising:
communicating the positioning instruction as a proximity instruction by activating a plurality of concentric rings of the indicator device sequentially outward away from the status icon in response to the proximity instruction indicating the object is too close to the scanning device.

17. The method according to claim 14, further comprising:
communicating the positioning instruction as a proximity instruction by activating a plurality of concentric rings of the indicator device sequentially inward toward the status icon in response to the proximity adjustment indicating the object is too far from the scanning device.

18. The method according to claim 14, wherein the indicator device comprises intermediate segments disposed between each of the directional segments, and wherein the directional segments and the intermediate segments are radially aligned forming a plurality of concentric rings extending about the perimeter of the status icon.

19. A feedback apparatus for a user identification system of a vehicle, the apparatus comprising:
an indicator device configured to selectively illuminate a status icon and a plurality of directional segments circumferentially spaced around the status icon, wherein the directional segments form a plurality of concentric rings radially spaced about a perimeter of the status icon; and
a controller in communication with a scanning device configured to authenticate an object depicted in image data representing a field of view, wherein the controller is configured to:
identify a position of the object in the field of view;
generate a positioning instruction in response to the position of the object;
activate at least one of the directional segments in a positioning direction relative to the status icon in response to the positioning instruction indicating the position of the object is to be directionally repositioned; and
sequentially activate the plurality of concentric rings in response to the positioning instruction indicating the position of the object is to be repositioned to a different proximity relative to the scanning device.

20. The feedback apparatus according to claim 19, wherein the directional segments each form arc-shaped segments spaced about a perimeter of the status icon in each of four directions positioned centrally along a vertical axis and a horizontal axis that bisect the status icon.
